(19) United States
(12) Patent Application Publication
(10) Pub. No.: US 2012/0214713 A1
(43) Pub. Date: Aug. 23, 2012

(54) Method for Adjusting and Controlling Microbial Enhanced Oil Recovery

(75) Inventors: Bozhong Mu, Shanghai (CN); Jinfeng Liu, Shanghai (CN); Shizhong Yang, Shanghai (CN); Hongze Gang, Shanghai (CN)

(73) Assignee: EAST CHINA UNIVERSITY OF SCIENCE AND TECHNOLOGY, Shanghai (CN)

(21) Appl. No.: 13/504,947

(22) PCT Filed: Dec. 21, 2009
(86) PCT No.: PCT/CN2009/001526

§ 371 Date: Apr. 28, 2012

(30) Foreign Application Priority Data
Oct. 30, 2009 (CN) 200910197995.4

(51) Int. Cl. C09K 8/582

(52) U.S. Cl. 507/201

(57) ABSTRACT

The invention discloses a method for adjusting and controlling microbial enhanced oil recovery, which comprises the following steps: (1) analyzing the microbial community structure in produced fluid of an oil reservoir via molecular biological method and/or detecting the metabolites in the produced fluid; (2) adjusting the microorganism(s) to be injected into the oil reservoir and/or the nutrient system corresponding to the microorganism(s); (3) injecting the adjusted microorganism(s) and/or the nutrient system corresponding to the microorganism(s) into the oil reservoir through a water injection well; and (4) obtaining the crude oil from a corresponding beneficial oil producing well. Compared with the prior art, the method of the present invention adjusts microbial community structure in the oil reservoir to evolve toward the direction of facilitating oil production, and the performance of the functional microorganism(s) can be completely realized; the nutrient system is pertinently injected to avoid the blindness of using the nutrient system. Therefore, the method is scientific, economical and effective for the microbial enhanced oil recovery.

### FIELD OF THE INVENTION

The invention relates to the crude oil exploration and recovery technology, in particular to a method for adjusting and controlling microbial enhanced oil recovery.

### BACKGROUND OF THE INVENTION

Due to the complexity of the geological condition of the continental reservoir in China, approximately two-thirds of the crude oil has remained in the underground after water flooding, and the oil recovery ratios are generally low. In addition, reserves replacement is difficult. In view of such severe situations, it is urgent to develop technologies that can improve oil recovery ratios with high efficiency and strong adaptability to meet the energy demand of the society.

It has been reported in the literature that the microbial flooding, which is considered as a technique with wide application range and great potential in the area of improving oil recovery ratios, and has a broad application prospect. This technology utilizes beneficial actions (oil degradation) and metabolites (biosurfactant) of microorganism to improve the oil recovery ratios. The microbial flooding technology has been started since the 1920's, and it was much promoted due to the World Wide Oil Crisis in the 1970's. In recent 35 years, more than 30 microbial flooding field experiments were carried out in U.S., Poland, Former Soviet Union, Romania and other countries, and some good experimental results were obtained. The realistic effectiveness of microbial enhanced oil recovery has been proved according to the field experiments, however, it's also found that the improvement of oil recovery ratio by using microbial flooding technology is limited and technological level is still low. The lack of entire and systematical knowledge of microorganisms in oil reservoir is one of the reasons leading to the situation.

It has been confirmed in researches that the oil reservoir with long-term water flooding is a complex ecosystem, in which various species of microorganisms are cultivated and play an important role in the whole ecosystem. However, being limited by analysis methods, only a small part of microorganisms (about 1-3%) in oil reservoirs can be determined by methods based on a pure culture, and most microorganisms can not be determined because of incapability of being cultured. These microbial community structures and functions of the microorganisms have become a blind area in the knowledge of microorganisms in oil reservoirs.

The appearance of molecular biology methods, especially molecular ecology, overcomes the defects of conventional culture methods, and the method has been applied to the analysis of environmental microorganism ecology, such as soil, activated sludge and biological fertilizer, and provides a feasible method for systematically understanding microorganism ecology. A new, systematic and comprehensive knowledge of microorganisms in oil reservoir would be successfully obtained by applying such theory and methods to the analysis of microbial community structure in oil reservoir environment. In fact, microbial flooding is the method based on adjusting the microbial community structure in oil reservoir, and establishing or optimizing the biological environment for the oil flooding community to achieve the aim that the microbial community with oil flooding function becomes the dominant community in the oil reservoir environment. The microbial flooding designs and experiments based on this knowledge are more scientific and practical, and thereby would greatly improve the oil recovery ratio.

In the prior art, the culture method was adopted to analyze microbial community structure in an oil reservoir, but only a small part of microorganisms in the oil reservoir can be reflected in the results and the goal of comprehensive and systematic knowledge of communities and functions of microorganisms in the oil reservoir can not be achieved. On this basis, a nutrient system or minority strains were injected in the oil reservoir to change the community composition and develop the oil flooding function of microorganisms. Due to the great blindness and randomicity thereof, it was difficult to achieve the goal of stably improving oil recovery ratio.

### SUMMARY OF THE INVENTION

The object of the present invention is to overcome the defects of the prior art and provide a method for adjusting and controlling microbial enhanced oil recovery with high pertinence, elevating utilization rate and fully playing performance advantages thereof.

The object of the present invention is realized through the following technical solution: a method for adjusting and controlling microbial enhanced oil recovery, comprising the following steps: (1) analyzing the microbial community structure in produced fluid of an oil reservoir via molecular biological method and/or detecting metabolites in the produced fluid; (2) adjusting the microorganism(s) to be injected into the oil reservoir and/or a nutrient system corresponding to the microorganism(s); (3) injecting the adjusted microorganism(s) and/or the nutrient system corresponding to the microorganism(s) into the oil reservoir through a water injection well; and (4) obtaining a crude oil from a corresponding beneficial oil producing well.

The molecular biological method described in step (1) comprises steps of collecting a water sample from an experimental oil reservoir, extracting microbial community genomic DNA, amplifying 16S rRNA gene, establishing a genomic library after sequencing, using a RFLP method to analyze the microbial community diversity of the oil reservoir to obtain a microbial community structure in the oil reservoir environment, and analyzing microbial abundance through RT-PCR to obtain microbial composition structure information of the oil reservoir, wherein said detecting metabolites in the produced fluids comprises the step of analyzing glycolipid content or lipopeptide content in the produced fluid to obtain information of metabolites.

Adjusting the microorganisms to be injected into the oil reservoir and/or a nutrient system corresponding to the microorganisms in step (2) is operated on the basis of the analysis results of the step (1). If the concentration of functional microorganism(s) is higher than 1% of the concentration achieved in laboratory culture conditions, there is no need to inject the microorganism(s) and the nutrient system corresponding to the microorganism(s) into the oil reservoir; if the concentration of functional microorganism(s) is lower that 1% of the concentration achieved in laboratory culture conditions and the concentration of metabolites is higher than 0.1% of the concentration achieved in laboratory culture conditions, injecting the nutrient system corresponding to the microorganism into the oil reservoir; and if the concentration of functional microorganism(s) is lower that 1% of the concentration achieved in laboratory culture conditions and the concentration of metabolites is lower than 0.1% of the concentration achieved in laboratory culture conditions, injecting the microorganism(s) and the nutrient system corresponding to the microorganism(s) into the oil reservoir.

The microorganism(s) to be adjusted and injected into the oil reservoir comprise one or more microorganism(s) capable of metabolically producing biosurfactant and degrading hydrocarbons.

The microorganism(s) to be adjusted and injected into the oil reservoir further comprise one or more microorganism(s) capable of stimulating a microbial community originally existing in the oil reservoir to metabolize glycolipid or lipopeptide products.

The microorganism(s) is/are selected from Bacillus subtilis, Clostridium acetobutylicum, Bacillus stearothermophilus, G. uzenensis, Geobacillus subterraneus, Bacillus lentus, Pseudomonas aeruginosa, Enterobacter cloacae, Halobacterium halobium, Pseudomonas fluorescens and Pseudomonas putida.

Preferably, the microorganism(s) is/are selected from Bacillus subtilis, Pseudomonas putida and Bacillus stearothermophilus.

The nutrient system corresponding to the microorganism(s) is that the mass ratio of carbon source to nitrogen source therein is adjusted to be “(5-25):1”, so as to stimulate the functional microorganism(s) or metabolite(s) to be the dominant microorganism(s) or main metabolite(s).

The carbon source is selected from sucrose, glucose, starch and crude oil, and the nitrogen source is selected from peptone, ammonium chloride and ammonium nitrate.

Injecting the adjusted microorganism(s) and/or the nutrient system corresponding to the microorganism(s) into the oil reservoir as described in step (3) is operated in the manner of injecting the microbial fermentation broth and the nutrient system corresponding to the microorganism, separately, into the experimental oil reservoir through a water injection well, or injecting the microbial fermentation broth and the nutrient system corresponding to the microorganism, sufficiently mixed, into the experimental oil reservoir through a water injection well.

Compared with the prior art, in the present invention, in accordance with the method of “analyzing the community composition - adjusting microorganism(s) to be injected and/or the nutrient system corresponding to the microorganism(s) to be injected—injecting the microorganism and/or nutrient system”, the operation can be carried out repeatedly to promote a microbial community in an oil reservoir to become a system that is beneficial to microbial enhanced oil recovery, in which the injected microorganism(s) are the dominant bacteria co-existing with other microorganism(s). The oil flooding is carried out cooperatively and the oil flooding performance of the injected microorganism(s) is further improved. Therefore, the effect of the injected microorganism(s) and the nutrient solution can be maximized to a great extent in the present invention.

The method of the invention comprises steps of firstly analyzing the microbial community structure originally existing in an oil reservoir, and adjusting types of microorganism(s) and the composition of nutrient system to be injected thereby, so that functional microorganism(s) to be the dominant microorganism in the oil reservoir and the oil flooding effect of the functional microorganism is maximized. However, microbial enhanced oil recovery experiments have been performed in the prior art in the condition of lacking comprehensive and systematic knowledge of microbial community structures and activities in the oil reservoir. On the contrary, injected microorganism(s) and the nutrient system in the method of present invention have strong pertinence, high utilization rate and fully play performance advantages thereof Also, they can help the microorganism originally existing in the oil reservoir to exert the performance of oil flooding. Therefore, the method of the invention is a scientific, economical and effective microbial enhanced oil recovery method.

### DETAILED DESCRIPTION OF THE INVENTION

The invention will be described in details by combining the following embodiments.

### EXAMPLE 1

(1) Adjustive Effects of Different Nutrient Systems and Temperatures on the Growth and Metabolism of Microorganism(s)

System composition: formation water of an oil reservoir+crude oil or sucrose+oil flooding microbial strain+baseline microbial strain (microorganism(s) in the formation water and microorganism(s) in active sludge)+nutrient system, wherein the oil flooding bacteria include hydrocarbon degrading bacteria TF2 and biosurfactant producing bacteria HN1. TF2 is capable of growing by using glucose and n-hexadecane as a carbon source. When using a hydrocarbon mixture of n-hexadecane to n-docosane as a carbon source in the culture process, TF2 gives priority to n-hexadecane. TF2 grows better in the condition of temperature of 50° C.˜65° C., pH=6˜9, and salinity smaller than 2% (NaCl), and grows best in the condition of temperature of 55° C., pH=7, and salinity of 0.5% (NaCl). It is identified that the hydrocarbon degrading bacteria TF2 is G. subterraneus Str.34T. HH1 bacteria is uniform in size and light in color and has high movement frequency. The HN1 bacterial colony is fine and compact, yellow and opaque, its surface is flat, rough and beruffled, the edge of the colony is irregular, single colony is small and is easy to be picked up. It is identified that HN1 is B. subtilis. The carbon source in the nutrient system is sucrose (1%) or crude oil (1%), or their mixture (0.5% +0.5%), the nitrogen source is peptone (0.25%) or ammonium chloride (0.2%), additionally yeast extract (0.2%) and K₂HPO₄(0.08%), NaH₂PO₄(0.04%), MgSO₄.7H₂O (0.02%), CaCl₂.2H₂O(0.01%), and NaCl (0.02%). The cultures are carried out at 37° C., 55° C. and 65° C., respectively, and transferred four times to study the adjusting and controlling effects of different carbon sources and nitrogen sources on the metabolic performances and community structures of microorganism(s).

Results of adjusting and controlling cultures are: even starting from the same system, both community and function of a system change obviously under the adjustment and controlling of different carbon sources, nitrogen sources and temperatures.

The concentration of microbiome is the highest at 37° C., the dominant bacteria is HN1, a favorable emulsifying effect is obtained when taking the mixture of sucrose and crude oil as a carbon source whichever of peptone and ammonium chloride is the nitrogen source. When taking sucrose as the carbon source and peptone as the nitrogen source, the content of lipopeptide in the system reaches to 180mg/L, and the surface tension is reduced by 29%.

The concentration of microbiome is slightly lower at 55° C., the dominant bacteria is TF2, a favorable emulsifying effect is obtained when taking crude oil as a carbon source and peptone as a nitrogen source, and when taking the mixture of sucrose and crude oil as the carbon source and peptone as the nitrogen source, the content of lipopeptide in the system reaches to 320mg/L, and the surface tension is reduced by 25%.

The concentration of microbiome is the lowest at 65° C., the strains in the baseline reproduce to become the dominant bacteria in the microbiome, a favorable emulsifying effect is obtained when taking the mixture of sucrose and crude oil as a carbon source and ammonium chloride as a nitrogen source. When taking sucrose as the carbon source and peptone as the nitrogen source, the content of lipopeptide in the system reaches to 200 mg/L, and the surface tension is reduced by 30%.

Therefore, when the nutrient systems are formed by different carbon sources and nitrogen sources to cultivate the same stain at different temperatures, the dominant bacteria cultivated in the system is different, the yield of surfactant obtained in the nutrient system is different, and the reduction of surface tension is different. Therefore, the performance of a target microorganism can be maximized by pertinently selecting a nutrient system according to different temperature of an oil reservoir to improve the effect of microbial on enhanced oil recovery.

(2) Preferred Pseudomonas Aeruginosa Nutrient System

It's shown in the orthogonal experiments results that the preferred carbon source and nitrogen source for Pseudomonas aeruginosa producing glycolipid in fermentation process are soybean oil and sodium nitrate, respectively. The preferred nutrient substrate formula is as follows: 0.2 g/L of yeast extract, 120 g/L of soybean oil, 6.5 g/L of NaNO₃, 1.0 g/L of KH₂PO₄, 1.0 L of Na₂HPO₄.12H₂O, 0.1 g/L of MgSO₄.7H₂O, and 0.2 g/L of FeSO₄.7H₂O.

(3) Preferred Pseudomonas Putida Nutrient System

Through single factor experiments and orthogonal experiments, the nutrient systems for Pseudomonas putida producing glycolipid in fermentation process are studied and the results show that the preferred composition is as follows: the carbon source of 0.5% sucrose+0.5% crude oil, the nitrogen source of 0.2% ammonium chloride, 0.2% yeast extract, 0.08% KH₂PO₄, and 0.04% NaH₂PO₄.

(4) Analysis of Microbiome Structure in the Oil Reservoir

The bacterial diversity in a water sample produced from an oil reservoir is evaluated via a RFLP fingerprint pattern analysis method, the results show that in 74 operational taxonomical units (OTU), four most abundant OTUs account for 73.6% of total clones, and the abundances of remaining 70 OTUs are at low levels, of which 57 OTUs are represented by a single clone. The dominant microflora is obvious in the oil reservoir environment, the quantity of the primary bacterial accounts for over half of the total quantity, of which the most abundant bacterial accounts for 47.7% of the total, indicating that the bacterial is possibly suitable for high-temperature and high-pressure environmental conditions of the oil reservoir.

The 16S rRNA gene library analysis method is combined with the RFLP fingerprint pattern analysis method to analyze diversity of bacteria and archaea community in a high-temperature water flooding onshore reservoir environment in China to obtain the following bacterial species and amount: Gamme-Proteobacterial (85.7%), Thermotogales (6.8%), Epsilon-Proteobacteria (2.4%), Low-G+C Gram-positive (2.1%), High-G+C Gram-positive, Beta-Proteobacteria and Nitrospira (all less than 1.0%). Among them, thermophilic bacterial is more in species, while mesophilic bacteria, such as Pseudomonas is more in amount. Archaea obtained mainly belongs to methanogenic archaea, including Methanobacteriales, Methanococcales, Methanomicrobiales and Methanosarcinales, among which Methanomicrobiales is the dominant archaea. A total of 28 sequence types are divided into three categories: (1) mesophilic methanogens, mainly including Methanosarcina, Methanohalophdus, Methanocalculus and Methanosaeta, etc.; (2) thermophilic methanogens, mainly including Methanothermobacter, Methanococcus and Methanoculleus; (3) uncultivated archaea. Among them, most bacteria are discovered before, but the minority show little similarity to bacteria reported before and may be new types of bacteria. Several detected thermophilic methanogens were discovered before in other oil reservoir environments, indicating that they might be widely distributed in high-temperature oil reservoir environments. Researches show that hydrogenotrophic methanogenic bacteria co-exists with aceticlastic methanogens in the oil reservoir.

Diversity of microorganism community in a selected typical offshore high-temperature water flooding oil reservoir in China is studied via the 16S rRNA sequence analysis method. The results show that bacterial types mainly belong to Firmicutes, Thermotogae, Nitrospirae and Proteobacteria, whereas archaea types mainly belong to Methanothermobacter, Methanobacter, Methanobrevibacter and Methanococcus, etc., and only one clone belongs to Thermoprotei. The diversity of bacteria is higher than that of archaea, the dominant bacteria microflora includes a few of types of methanogens, zymocytes and sulfate-reducing bacteria, indicating that the microbial diversity of the oil reservoir environment is relatively lower than other environments. A bacterium having close relationship with Hydrocarboniphaga effusa is first discovered in an oil reservoir environment, such bacteria is capable of degrading hydrocarbon and aromatic hydrocarbon, and probably is suitable for growing in oil reservoir environment. In addition, there are still a part of bacteria with sequence type incapable of being found in database for over 97% of genetic relationship.

(5) Simultaneously Injecting Nutrient System and Microbial Fermentation Broth to Improve the Application Effect of Microbial on Enhanced Oil Recovery

A microbial flooding experimental area is Injection 8 production well in No.3 Oil Field, in which the average porosity of a reservoir is 28%, the average air permeability is 0.7 um², the oil reservoir temperature is 53° C., the formation oil viscosity is 21 mPa.s, the ground degassed oil density is 0.92 g/cm³, the wax content is 8.8%, the colloidal bitumen content is 14.6%, the freezing point is −8° C., the geological reserve is 75×10⁴t, the type of formation water is NaHCO₃, and the salinity is 5528 mg/L.

7426 m³ of bacteria solution and nutrient solution is first injected into the microbial flooding experimental area, in which the bacteria solution injected is 120 m³ (GX-043: Pseudomonas putida, 60 m³; GX-104: Geobacillus subterraneus, 40 m³; GX-118: Bacillus stearothermophilus, 20 m³). The yield of the oil well approximates to the level before the injection of the bacteria after 26 months. The abundances of the injected bacteria are detected by RT-PCR technique:

B. Stearothermophilus

Upstream primer
5′-CCCTGACAACCCAAGAGATT-3′
Downstream primer
5′-ATCTCACGACACGAGCTGAC-3′
Fluorescence probe gene sequence
5′-AACCATGCACCACCTGTCACCC-3′

G. Subterraneus

Upstream primer
5′-CCCTGACAACCCAAGAGATT-3′
Downstream primer
5′-ATCTCACGACACGAGCTGAC-3′
Fluorescence probe gene sequence
5′-AACCATGCACCACCTGTCACCC-3′

P. Putida

Upstream primer
5′-GTCAGCTCGTGTCGTGAGAT-3′
Downstream primer
5′-CTCCTTAGAGTGCCCACCAT-3′
Fluorescence probe gene sequence
5′-CCCGTAACGAGCGCAACCCT-3′

The report fluorophore group marked on the end of probe gene sequence 5′ is FAM, and the quenching fluorophore group marked on the end of probe gene sequence 3′ is TAMRA. The result shows that compared with that in peak period of response, the concentration of GX-043 is reduced from 10² cell/ml to 10⁵ cell/ml, and community structure has changed obviously, the ratio of the injected functional microorganism(s) of “GX-043:GX-104:GX-118” changes from 7:4:2 to 5:5:3; the glycolipid content detected in produced fluid of the oil well is only 0.06% of that under laboratory culture condition. Therefore, 54 m³ of GX-043 fermentation broth and 540 m³ of corresponding nutrient solution are simultaneously injected into the experimental oil reservoir. According to laboratory study, the bacteria grows vigorously when taking 0.5% sucrose+0.5% crude oil as a carbon source and 0.2% ammonium chloride as a nitrogen source, and in view of the existence of crude oil in the oil reservoir, actually, the injected nutrient solution is composed of 0.5% sucrose, 0.2% ammonium chloride, 0.2% yeast extract, 0.08% K₂HPO₄, and 0.04% NaH₂PO₄. The fermentation broth and the bacterial solution are mixed evenly and then injected into the oil reservoir through water injection well.

After the injection of the nutrient solution and the fermentation broth of the main bacteria, the abundance of GX-043 gradually increases, and the ratio of the three bacteria approximates to the initial level. The average daily oil production of single well of a beneficial oil well increases from 2.2 t to 4.7 t, the composite water cut decreases from 93.7% to 90.2%, and accumulated oil increase of the area with microbial enhance oil recovery reaches to 3400 t.

(6) Single Injection of a Nutrient System for Improving the Application Effect of Microbial on Enhanced Oil Recovery Technique

A microbial flooding experimental area is Injection 5 production well in Oil Field No.2, in which the average porosity of a reservoir is 22%, the average air permeability is 0.83 um², the oil reservoir temperature is 38° C., the formation oil viscosity is 19 mPa.s, the ground degassed oil density is 0.90 g/cm³, the wax content is 20.2%, the colloidal bitumen content is 10.6%, the geological reserve is 60×10⁴ t, the type of formation water is NaHCO₃, and the salinity is 7137 mg/L.

4320 m³ of bacteria solution and nutrient solution is first injected into the microbial flooding experimental area, in which the bacteria solution injected is 320 m³. The abundances of the injected bacteria are detected by RT-PCR technique after 18 months:

B. Subtilis

Upstream primer
5′-GTGTCTCAGTCCCAGTGTGG-3′
Downstream primer
5′-GCGCATTAGCTAGTTGGTGA-3′
Fluorescence probe gene sequence
5′-ACGGCTCACCAAGGCAACGA-3′
Total bacteria
Upstream primer
5′-AGAGTTTGATCCTGGCTCAG-3′
Downstream primer
5′-TACGGYTACCTTGTTACGACTT-3′

The report fluorophore group marked on the end of probe gene sequence 5′ is FAM, and the quenching fluorophore group marked on the end of probe gene sequence 3′ is TAMRA. Analysis shows that compared with peak period of response, community structure has changed, but the abundance of the injected functional microorganism DQ-003 (B. subtilis) changes little (decreases from the highest of 9.1% to 7.8%); the concentration still remains at 7*10⁶ cell/mL, in this case the lipopeptide content detected in produced fluid of the oil well is only 0.2% of that under laboratory culture condition. Therefore, 650 m³ of nutrient solution corresponding to DQ-003 is injected into the experimental oil reservoir. According to laboratory study, the nutrient solution consist of 1% sucrose and 0.25% peptone, additionally adding yeast extract (0.2%), K₂HPO₄(0.08%) and NaH₂PO₄(0.04%). The bacterium grows vigorously in the nutrient system.

After the injection of the nutrient solution, the concentration of functional microorganism DQ-003 (B. subtilis) returns to 2*10⁷ cells/mL, The average daily oil production of single well of a beneficial oil well increases from 1.2 t to 1.9 t, the composite water cut decreases from 95.7% to 95.0%, and accumulated oil increase of the area with microbial enhance oil recovery reaches to 605 t.

### EXAMPLE 2

Method for adjusting and controlling microbial oil recovery comprises the following steps:

(1) Using Molecular Biological Methods, Including 16S rDNA Library, PCR-DGGE, and RT-PCR to Analyze Microbial Community Structure in Produced Fluid of the Oil Reservoir:

Firstly, collecting a water sample from an experimental oil reservoir, then according to the method disclosed by the Molecular Analysis of Microbial Community Diversity of Oil Reservoir (Li Hui, Ph.D. Dissertation. East China University of Science and Technology, 2007), extracting microbial community genome DNA, amplifying 16S rRNA gene, establishing a genomic library after sequencing, using a RFLP method to analyze microbial community diversity of the oil reservoir to obtain a microbial composition structure in the oil reservoir environment; and according the method disclosed by the Detection of Abundance of Pseudomonas Sp in Environmental Samples by Real-Time Quantitative PCR (Zhao Chuanpeng et al., Journal of Southeastern University, 2006, 36(1)), analyzing microbial abundance through RT-PCR. The microbial composition structure information of the oil reservoir is obtained by above methods.

(2) Adjusting the Composition of Microorganism(s) to be Injected into the Oil Reservoir

The concentration of a functional microorganism is 2×10⁸ cell/mL under laboratory culture condition. Based on the analysis results of the step (1), if the concentration of a functional microorganism is higher than 1% of the concentration achieved under laboratory culture condition, there is no need to inject the microorganism; and if the concentration of a functional microorganism is lower that 1% of the concentration achieved in laboratory culture, then injecting the microorganism into the oil reservoir.

The microorganism(s) commonly used in oil recovery include Bacillus subtilis (such as B. subtilis, CGMCC1.400), Clostridium acetobutylicum (such as C. acetobutylicum, CGMCC 1.244), Bacillus stearothermophilus (such as B. stearothermophilus, CGMCC 1.1923), G. uzenensis (such as CGMCC 1.2674), Geobacillus subterraneus (such as G. subterraneus CGMCC 1.2673), Bacillus lentus (such as B. lentus, CGMCC1.2013), Pseudomonas aeruginosa (such as P. aeruginosa, CGMCC1.1785), Enterobacter cloacae (such as E. cloacae, CGMCC1.2022), Halobacterium halobium (such as H. salinarium, CGMCC1.1952), Pseudomonas fluorescens (such as P. fluorescens, CGMCC1.1802), Pseudomonas putida (such as P. putida, CGMCC1.1820), etc., but are not limited to above microorganism(s). Bacillus subtilis, Pseudomonas putida and Bacillus stearothermophilus are preferred.

(3) Injecting the Adjusted Microorganism(s) or the Nutrient System into the Oil Reservoir Through the Water Injection Well

The injection mode is that the microbial fermentation solution is injected according to 0.01% of pore volume controlled by experimental well group, and the microbial solution is injected into the experimental reservoir through the water injection well.

(4) Obtaining Crude Oil from the Corresponding Beneficial Oil Production Well.

According to the normal working system of oil field development, crude oil is directly obtained from the beneficial oil production well without changing any oil recovery process parameter.

### EXAMPLE 3

Method for adjusting and controlling nutrient system corresponding to microorganism(s) for oil recovery comprises the following steps:

(1) detecting metabolites in the produced fluids:

Analyzing glycolipid content in the produced fluid of the oil well according to the method disclosed by Studies on Optimum Conditions of Preparation of Rhamnose by Microbial Fermentation (Li Zuyi et al., Chinese Journal of Biotchnology, 1999 (1)) and analyzing lipopeptide content according to the method disclosed by Determination of the Lipopeptide Biosufactant in Cell-Free Broth (Chen Tao et al., Oilfield Chemistry, 2004(4)) to obtain metabolites information of functional microorganism(s) in the oil reservoir. The abundance and activity information of the microorganism(s) producing the metabolites are obtained according to the analysis of the change of the metabolites.

(2) Adjusting composition of a nutrient system to be injected into the oil reservoir: obtaining metabolite information by analyzing glycolipid content or lipopeptide content in the produced fluid, and making a decision on the basis of the analysis results of the step (1). If the concentration of a functional microorganism is higher than 1% of the concentration achieved under laboratory culture condition (the concentration of the functional microorganism is 2×10⁶ cell/mL under laboratory culture condition), there is no need to inject the nutrient system corresponding to the microorganism into the oil reservoir; whereas if the concentration of a functional microorganism is lower that 1% of the concentration achieved under laboratory culture condition and the concentration of metabolites is higher than 0.1% of the concentration achieved under laboratory culture condition, injecting the nutrient system corresponding to the microorganism into the oil reservoir; and by taking sucrose as a carbon source and peptone as a nitrogen source, adjusting the mass ratio of “carbon source to nitrogen source” to be “5:1” so as to stimulate the functional microorganism(s) or metabolites to become the dominant microorganism(s) or main metabolites.

(3) Injecting the adjusted nutrient system into the oil reservoir through a water injection well: amount of the nutrient system injected into the experimental reservoir through the water injection well is determined according to 0.1% of pore volume controlled by experimental well group.

(4) Obtaining crude oil from the corresponding beneficial oil production well.

### EXAMPLE 4

Method for adjusting and controlling microorganism and nutrient system corresponding to the microorganism(s) for oil recovery comprises the following steps:

(1) Microbial community structure in produced fluid of an oil reservoir are analyzed by using molecular biological methods including 16S rDNA library, PCR-DGGE, and RT-PCR and biological metabolites of biosurfactant, organic acid, etc. in the produced fluid are detected by utilizing instrument analysis methods.

Collecting a water sample from an experimental oil reservoir, according to the method disclosed by the Molecular Analysis of Microbial Community Diversity of Oil Reservoir (Li Hui, Ph.D. Dissertation. East China University of Science and Technology, 2007), extracting microbial community genome DNA, amplifying 16S rRNA gene, establishing a genomic library after sequencing, analyzing evolution information of a microbial system, building a phylogenetic tree, using a RFLP method to analyze microbial community diversity of the oil reservoir to obtain a microbial community structure in the oil reservoir environment; adopting the method disclosed by the Molecular Analysis of Microbial Community Diversity of Oil Reservoir (Li Hui, Ph.D. Dissertation. East China University of Science and Technology, 2007) to analyze the diversity of alkane degradation gene (aIkB) in the oil reservoir environment via PCR-DGGE fingerprint pattern method; according the method disclosed by the Detection of Abundance of Pseudomonas Sp in Environmental Samples by Real-Time Quantitative PCR (Zhao Chuanpeng et al., Journal of Southeastern University, 2006, 36(1)), analyzing the abundance of a functional microorganism through RT-PCR; analyzing bacteria concentration via a microscope-blood counting chamber counting method; and obtaining microbial composition structure information of the oil reservoir by above methods.

Analyzing glycolipid content in the produced fluid of an oil well according to the method disclosed by Studies on Optimum Conditions of Preparation of Rhamnose by Microbial Fermentation (Li Zuyi et al., Chinese Journal of Biotchnology, 1999 (1)) and analyzing lipopeptide content according to the method disclosed by Determination of the Lipopeptide Biosufactant in Cell-Free Broth (Chen Tao et al., Oilfield Chemistry, 2004(4)) to obtain metabolites information of functional microorganism(s) in the oil reservoir. The abundance and activity information of the microorganism(s) producing the metabolites are obtained according to the analysis of the change of the metabolites.

(2) Adjusting composition of microorganism and a nutrient system to be injected into the oil reservoir:

According to the analysis results of the step (1), if the concentration of a functional microorganism is higher than 1% of the concentration achieved under laboratory culture condition (the concentration of the functional microorganism is 2×10⁶ cell/mL under laboratory culture condition), there is no need to inject the microorganism and the nutrient system corresponding to the microorganism into the oil reservoir; if the concentration of a functional microorganism is lower that 1% of the concentration achieved under laboratory culture condition and the concentration of metabolites is higher than 0.1% of the concentration achieved under laboratory culture condition, injecting the nutrient system corresponding to the microorganism(s) into the oil reservoir; and if the concentration of a functional microorganism is lower that 1% of the concentration achieved under laboratory culture condition and the concentration of metabolites is lower than 0.1% of the concentration achieved under laboratory culture condition, injecting the microorganism(s) and the nutrient system corresponding to the microorganism(s) into the oil reservoir.

The microorganism(s) commonly used in oil recovery include Bacillus subtilis (such as B. subtilis, CGMCC1.400), Clostridium acetobutylicum (such as C. acetobutylicum, CGMCC 1.244), Bacillus stearothermophilus (such as B. stearothermophilus, CGMCC 1.1923), G. uzenensis (such as CGMCC 1.2674), Geobacillus subterraneus (such as G. subterraneus CGMCC 1.2673), Bacillus lentus (such as B. lentus, CGMCC1.2013), Pseudomonas aeruginosa (such as P. aeruginosa, CGMCC1.1785), Enterobacter cloacae (such as E. cloacae, CGMCC1.2022), Halobacterium halobium (such as H. salinarium, CGMCC1.1952), Pseudomonas fluorescens (such as P. fluorescens, CGMCC1.1802), Pseudomonas putida (such as P. putida, CGMCC1.1820), etc., but are not limited to above microorganism(s). Bacillus subtilis, Pseudomonas putida and Bacillus stearothermophilus are preferred.

By taking glucose as a carbon source and peptone as a nitrogen source, adjusting the mass ratio of “carbon source to nitrogen source” to be “25:1” to stimulate the functional microorganism(s) or metabolites to be the dominant microorganism(s) or main metabolites.

(3) Injecting the adjusted microorganism(s) or the nutrient system into the oil reservoir through a water injection well

The injection mode is that the microbial fermentation solution is injected according to 0.01% of pore volume controlled by experimental well group, and the nutrient system is injected in the amount according to 0.1% of pore volume controlled by experimental well group; if the nutrient solution and the microbial solution are simultaneously needed, they should be mixed well before the injection; and the microbial solution and the nutrient solution are injected into the experimental reservoir through a water injection well.

(4) Obtaining crude oil from a corresponding beneficial oil production well.

According to the normal working system of oil field development, crude oil is directly obtained from the beneficial oil production well without changing any oil recovery process parameter.

1. A method for adjusting and controlling microbial enhanced oil recovery, comprising the following steps: (1) analyzing the microbial community structure in produced fluid of an oil reservoir via molecular biological method and/or detecting metabolites in the produced fluid; (2) adjusting the microorganism(s) to be injected into the oil reservoir and/or a nutrient system corresponding to the microorganism(s); (3) injecting the adjusted microorganism(s) and/or the nutrient system corresponding to the microorganism(s) into the oil reservoir through a water injection well; and (4) obtaining a crude oil from a corresponding beneficial oil producing well.

2. The method for adjusting and controlling microbial enhanced oil recovery according to claim 1, wherein said molecular biological method in step (1) comprises steps of collecting a water sample from an experimental oil reservoir, extracting microbial community genomic DNA, amplifying 16S rRNA gene, establishing a genomic library after sequencing, using a RFLP method to analyze the microbial community diversity of the oil reservoir to obtain a microbial community structure in the oil reservoir environment, and analyzing microbial abundance through RT-PCR to obtain microbial composition structure information of the oil reservoir, wherein said detecting metabolites in the produced fluids comprises the step of analyzing glycolipid content or lipopeptide content in the produced fluid to obtain information of metabolites.

3. The method for adjusting and controlling microbial enhanced oil recovery according to claim 1, wherein said adjusting the microorganism(s) to be injected into the oil reservoir and/or a nutrient system corresponding to the microorganism in step (2) is operated on the basis of the analyzed results of the step (1), if the concentration of functional microorganism(s) is higher than 1% of the concentration achieved in laboratory culture conditions, there is no need to inject the microorganism(s) and the nutrient system corresponding to the microorganism(s) into the oil reservoir; if the concentration of functional microorganism(s) is lower that 1% of the concentration achieved in laboratory culture conditions and the concentration of metabolites is higher than 0.1% of the concentration achieved in laboratory culture conditions, injecting the nutrient system corresponding to the microorganism into the oil reservoir; and if the concentration of functional microorganism(s) is lower that 1% of the concentration achieved in laboratory culture conditions and the concentration of metabolites is lower than 0.1% of the concentration achieved in laboratory culture conditions, injecting the microorganism(s) and the nutrient system corresponding to the microorganism(s) into the oil reservoir.

4. The method for adjusting and controlling microbial enhanced oil recovery according to claim 3, wherein said microorganism(s) to be adjusted and injected into the oil reservoir comprise one or more microorganism(s) capable of metabolically producing biosurfactant and degrading hydrocarbons.

5. The method for adjusting and controlling microbial enhanced oil recovery according to claim 3, wherein said microorganism(s) to be adjusted and injected into the oil reservoir further comprise one or more microorganism(s) capable of stimulating a microbial community originally existing in the oil reservoir to metabolize glycolipid or lipopeptide products.

6. The method for adjusting and controlling microbial enhanced oil recovery according to claim 4, wherein said microorganism(s) is/are selected from Bacillus subtilis, Clostridium acetobutylicum, Bacillus stearothermophilus, G. uzenensis, Geobacillus subterraneus, Bacillus lentus, Pseudomonas aeruginosa, Enterobacter cloacae, Halobacterium halobium, Pseudomonas fluorescens and Pseudomonas putida.

7. The method for adjusting and controlling microbial enhanced oil recovery according to claim 6, wherein said microorganism(s) is/are selected from Bacillus subtilis, Pseudomonas putida and Bacillus stearothermophilus.

8. The method for adjusting and controlling microbial enhanced oil recovery according to claim 1, wherein said nutrient system corresponding to the microorganism(s) is that the mass ratio of carbon source to nitrogen source therein is adjusted to be “(5-25):1”, so as to stimulate the functional microorganism(s) or metabolite(s) to be the dominant microorganism(s) or main metabolite(s).

9. The method for adjusting and controlling microbial enhanced oil recovery according to claim 8, wherein said carbon source is selected from sucrose, glucose, starch and crude oil, and the nitrogen source is selected from peptone, ammonium chloride and ammonium nitrate.

10. The method for adjusting and controlling microbial enhanced oil recovery according to claim 1, wherein the mode, in step (3), of injecting the adjusted microorganism(s) and/or the nutrient system corresponding to the microorganism(s) into the oil reservoir is to inject microbial fermentation broth or the nutrient system corresponding to the microorganism(s) into an experimental oil reservoir, separately, through a water injection well; or to inject the microbial fermentation broth and the nutrient system corresponding to the microorganism(s), sufficiently mixed, into the experimental oil reservoir through a water injection well.

11. The method for adjusting and controlling microbial enhanced oil recovery according to claim 5, wherein said microorganism(s) is/are selected from Bacillus subtilis, Clostridium acetobutylicum, Bacillus stearothermophilus, G. uzenensis, Geobacillus subterraneus, Bacillus lentus, Pseudomonas aeruginosa, Enterobacter cloacae, Halobacterium halobium, Pseudomonas fluorescens and Pseudomonas putida.

12. The method for adjusting and controlling microbial enhanced oil recovery according to claim 11, wherein said microorganism(s) is/are selected from Bacillus subtilis, Pseudomonas putida and Bacillus stearothermophilus.

13. The method for adjusting and controlling microbial enhanced oil recovery according to claim 3, wherein said nutrient system corresponding to the microorganism(s) is that the mass ratio of carbon source to nitrogen source therein is adjusted to be “(5-25):1”, so as to stimulate the functional microorganism(s) or metabolite(s) to be the dominant microorganism(s) or main metabolite(s).

14. The method for adjusting and controlling microbial enhanced oil recovery according to claim 13, wherein said carbon source is selected from sucrose, glucose, starch and crude oil, and the nitrogen source is selected from peptone, ammonium chloride and ammonium nitrate.


SEQUENCE LISTING (14 sequences)

SEQ ID NO: 1 - DNA, 20 bp, Artificial sequence
  Synthetic
ccctgacaacccaagagatt

SEQ ID NO: 2 - DNA, 20 bp, Artificial sequence
  Synthetic
atctcacgacacgagctgac

SEQ ID NO: 3 - DNA, 22 bp, Artificial sequence
  Synthetic
aaccatgcaccacctgtcaccc

SEQ ID NO: 4 - DNA, 20 bp, Artificial sequence
  Synthetic
ccctgacaacccaagagatt

SEQ ID NO: 5 - DNA, 20 bp, Artificial sequence
  Synthetic
atctcacgacacgagctgac

SEQ ID NO: 6 - DNA, 22 bp, Artificial sequence
  Synthetic
aaccatgcaccacctgtcaccc

SEQ ID NO: 7 - DNA, 20 bp, Artificial sequence
  Synthetic
gtcagctcgtgtcgtgagat

SEQ ID NO: 8 - DNA, 20 bp, Artificial sequence
  Synthetic
ctccttagagtgcccaccat

SEQ ID NO: 9 - DNA, 20 bp, Artificial sequence
  Synthetic
cccgtaacgagcgcaaccct

SEQ ID NO: 10 - DNA, 20 bp, Artificial sequence
  Synthetic
gtgtctcagtcccagtgtgg

SEQ ID NO: 11 - DNA, 20 bp, Artificial sequence
  Synthetic
gcgcattagctagttggtga

SEQ ID NO: 12 - DNA, 20 bp, Artificial sequence
  Synthetic
acggctcaccaaggcaacga

SEQ ID NO: 13 - DNA, 20 bp, Artificial sequence
  Synthetic
agagtttgatcctggctcag

SEQ ID NO: 14 - DNA, 22 bp, Artificial sequence
  Synthetic
tacggytaccttgttacgactt